(19) United States
(12) Patent Application Publication
(10) Pub. No.: US 2025/0393108 A1
(43) Pub. Date: Dec. 25, 2025

(54) LIGHTING UNIT, LIGHTING DEVICE, AND LIGHTING SYSTEM

(71) Applicant: SAVANT TECHNOLOGIES LLC, East Cleveland, OH (US)

(72) Inventors: Kun XIAO, Shanghai (CN); Jie GAO, Shanghai (CN); Yimin ZHU, Shanghai (CN)

(73) Assignee: SAVANT TECHNOLOGIES LLC, East Cleveland, OH (US)

(21) Appl. No.: 19/207,856

(22) Filed: May 14, 2025

(30) Foreign Application Priority Data
Jun. 19, 2024 (CN) 202421408070

(51) Int. Cl. H05B 45/10; F21V 23/00; F21Y 115/10; H05B 45/395; H05B 45/48

(52) U.S. Cl. CPC H05B 45/10; F21V 23/005; F21V 23/006; H05B 45/395; H05B 45/48; F21Y 2115/10

(57) ABSTRACT

Provided is a lighting unit, a lighting device and a lighting system. The lighting unit connects to a drive element and a dimmer and includes a light-emitting assembly having a plurality of light-emitting units connected in series, and a current limiting circuit that includes a current limiting element and is connected in parallel to some of the plurality of light-emitting units, so as to achieve the technical effects of the lighting unit, the lighting device and the lighting system capable of deep dimming and having a simple structure and low cost.

### CROSS-REFERENCE TO RELATED APPLICATIONS

This application claims priority to Chinese Patent Application Serial Number 202421408070, filed Jun. 19, 2024, which is herein incorporated by reference.

### TECHNICAL FIELD

The present application relates to a lighting unit, a lighting device, and a lighting system, and more particularly, to a lighting unit, a lighting device, and a lighting system capable of achieving deep dimming in a simple manner.

### BACKGROUND

Currently, as shown in FIG. 1, for a lighting device 200′, a dimmer 140, such as a phase control dimmer, is generally added before a drive element 120, such as a linear driver, connected to a light-emitting assembly 110, such as an LED light-emitting element, to dim the light-emitting assembly 110, i.e., adjust the brightness thereof. The phase control dimmer adjusts the turn-on time of the LED light-emitting elements in each alternating current period by changing the phase of the alternating current voltage waveform, so as to control the voltage across two ends of the LED light-emitting elements. During dimming, the effective value (root mean square (RMS) value) of the voltage output from the dimmer will be reduced. Since the output voltage and the input voltage of the linear driver are linearly related, when the dimmer is used to perform deep dimming (for example, reducing the brightness to 30%, 20%, 10%, etc.), the voltage output from the dimmer may be too low, causing the voltage output from the linear driver to be lower than the turn-on voltage of the LED light-emitting elements. As a result, deep dimming of the LED light-emitting elements is practically impossible. This problem can be solved using a switch mode power supply driver because it enables regulation of the voltage and current by adjusting the duty ratio (PWM control) of the switch, which allows it to handle a wide range of input voltages while maintaining a stable output voltage. However, the switch mode power supply driver has a complex design and high cost.

In view of this, it is desired to provide an improved lighting device capable of achieving deep dimming, and having a simple structure and low cost.

### SUMMARY OF THE INVENTION

In view of the described problems, a main object of the present application is to provide a lighting unit, a lighting device, and a lighting system capable of achieving deep dimming and having a simple structure and low cost, so as to solve the technical problem in the prior art that it is difficult for a lighting device to achieve deep dimming at low cost.

In order to achieve the described object, according to one aspect of the present application, provided is a lighting unit which is configured to connect to a drive element and a dimmer, the lighting unit comprising: a light-emitting assembly comprising a plurality of light-emitting units connected in series; and a current limiting circuit comprising a current limiting element, wherein the current limiting element is connected in parallel to some of the plurality of light-emitting units.

In this way, with the lighting unit of the present application, even if the voltage output from the drive element is lower than the overall turn-on voltage of the plurality of light-emitting units due to deep dimming of the dimmer, the remaining light-emitting units other than the light-emitting unit connected in parallel to the current limiting element among the plurality of light-emitting units can still emit light as long as the voltage output from the drive element is higher than the turn-on voltage of the remaining light-emitting units. Thus, the lighting unit of the present application can achieve deep dimming, as well as has a simple structure and low cost.

In addition, a current limiting circuit may be arranged according to a turn-on voltage of a light-emitting unit, the total number of light-emitting units, and the number of light-emitting units that are desired to be turned on during deep dimming, such that the current limiting element is connected in parallel to a predetermined number of light-emitting units. In this way, when a voltage output from a drive element is less than an overall turn-on voltage of the light-emitting units but greater than a turn-on voltage of the remaining light-emitting units other than the predetermined number of light-emitting units among the plurality of light-emitting units, the remaining light-emitting units can still emit light at a desired luminance.

Further, according to one embodiment of the present application, the light-emitting assembly further comprises at least one substrate, and the plurality of light-emitting units are distributed on the at least one substrate.

In this way, it is possible to arrange the current limiting circuit on the substrate or outside the substrate, thereby arranging the current limiting circuit in various forms.

Further, according to one embodiment of the present application, the light-emitting assembly comprises only one substrate, and the current limiting circuit is arranged on the substrate; or the light-emitting assembly comprises a plurality of substrates connected in sequence, at least one light-emitting unit is arranged on each of the substrates, and the current limiting circuit is arranged on one of the plurality of substrates or is arranged outside the plurality of substrates.

Further, according to one embodiment of the present application, the current limiting circuit is arranged on one substrate, and the current limiting element comprises a resistive material layer coated on a part of the surface of the substrate.

In this way, the current limiting element can be formed by coating the resistive material layer directly on the substrate by means of a semiconductor packaging process without the need for additional elements or wiring.

Further, according to one embodiment of the present application, the current limiting circuit further comprises conductive material layers coated on the surface of the substrate, the conductive material layers are arranged at two ends of the resistive material layer and extend outwards from the two ends of the resistive material layer, and the two extended ends of the conductive material layers are respectively in contact with two ends of the some of the light-emitting units.

In this way, the current limiting circuit can be formed by coating directly on the substrate by means of a semiconductor packaging process, without the need for additional elements or wiring; therefore, the current limiting circuit formed thereby is stable, is not easily damaged, and does not affect the appearance of a lighting device.

Further, according to one embodiment of the present application, the current limiting circuit is arranged on one substrate, the current limiting circuit further comprises a first conductive wire and a second conductive wire, one end of the current limiting element is connected to one end of the some of the light emitting units on the substrate via the first conductive wire, and the other end of the current limiting element is connected to the other end of the some of the light-emitting units via the second conductive wire.

In this way, the current limiting circuit is formed by additionally attaching a current limiting element, a first conductive wire and a second conductive wire on the substrate. This method uses a simple manufacturing process and does not affect the appearance of the lighting device.

Further, according to one embodiment of the present application, the light-emitting assembly comprises a plurality of substrates, and the current limiting circuit is arranged outside the plurality of substrates, wherein each substrate and at least one light-emitting unit arranged on the substrate form a filament. The current limiting circuit further comprises a first conductive wire and a second conductive wire, one end of the current limiting element is connected to one end of at least one pre-determined filament among the plurality of filaments via the first conductive wire, and the other end of the current limiting element is connected to the other end of the at least one filament via the second conductive wire.

In this way, the current limiting circuit is formed by additionally arranging a current limiting element in parallel with a preset number of the filaments outside the substrates and the filaments, without a complicated manufacturing process. Thus, the current limiting circuit is visible in the lighting device, making it easy to check whether the current limiting circuit is damaged, and facilitating the replacement of the current limiting circuit.

Further, according to one embodiment of the present application, the light-emitting assembly comprises a plurality of substrates, and the current limiting circuit is arranged outside the plurality of substrates, wherein each of the substrates and at least one light-emitting unit arranged on the substrate form a filament. The drive element comprises a first output end, a second output end and a third output end, wherein the first output end is connected to one end of the light-emitting assembly, the second output end is connected to the other end of the light-emitting assembly, and the third output end is connected to a point between two preset adjacent filaments among the plurality of filaments. The current limiting circuit further comprises a first conductive wire and a second conductive wire, one end of the current limiting element is connected to the third output end via the first conductive wire, and the other end of the current limiting element is connected to the first output end or the second output end via the second conductive wire.

In this way, the current limiting circuit is arranged in the drive element rather than in the light-emitting assembly or near the light-emitting assembly, and the process is simple, so that an improved lighting unit and lighting device having a simple structure and low cost and capable of achieving deep dimming can be formed.

Further, according to one embodiment of the present application, there are a plurality of current limiting circuits, and the sum of the number of the light-emitting units connected in parallel to the plurality of current limiting elements included in the plurality of current limiting circuits is less than the total number of the light-emitting units in the light-emitting assembly.

In this way, the current limiting circuit may be arbitrarily arranged according to a turn-on voltage of a light-emitting unit, the total number of light-emitting units, and the number of light-emitting units that are desired to be turned on during deep dimming, such that the current limiting element is connected in parallel to a predetermined number of light-emitting units, thereby achieving that when a voltage output from a drive element is less than an overall turn-on voltage of the light-emitting units but greater than a turn-on voltage of remaining light-emitting units other than the predetermined number of light-emitting units among the plurality of light-emitting units, the remaining light-emitting units emit light at a desired luminance.

Further, according to one embodiment of the present application, the light-emitting unit is an LED light-emitting unit.

Further, according to one embodiment of the present application, the current limiting element is a resistor, and the current limiting circuit is a resistor circuit.

In this way, the current limiting element and the current limiting circuit may be formed by using the resistor, that is, a bypass circuit of the some of the light-emitting units connected in parallel may be formed by using the resistor.

According to another aspect of the present application, provided is a lighting device which is configured to connect to a dimmer, the lighting device comprising: the described lighting unit, and a drive element, an output end of the drive element being connected to a light-emitting assembly of the lighting unit.

In this way, with the lighting unit of the present application, even if the voltage output from the drive element is lower than the overall turn-on voltage of the plurality of light-emitting units due to deep dimming of the dimmer, the remaining light-emitting units other than the light-emitting unit connected in parallel to the current limiting element among the plurality of light-emitting units can still emit light as long as the voltage output from the drive element is higher than the turn-on voltage of the remaining light-emitting units. Thus, the lighting device of the present application can achieve deep dimming, as well as has a simple structure and low cost.

Further, according to one embodiment of the present application, the drive element is a linear drive element.

In this way, when the voltage output from the drive element is lower than the overall turn-on voltage of the plurality of light-emitting units due to deep dimming of the dimmer, the remaining light-emitting units other than the light-emitting unit connected in parallel to the current limiting element among the plurality of light-emitting units can still emit light as long as the voltage output from the drive element is higher than the turn-on voltage of the remaining light-emitting units.

According to another aspect of the present application, provided is a lighting system, comprising: the described lighting device, and a dimmer, an output end of the dimmer being connected to an input end of a drive element of the lighting device.

Provided in an embodiment of the present application is a lighting unit which is configured to connect to a drive element and a dimmer, the lighting unit comprising: a light-emitting assembly, comprising a plurality of light-emitting units connected in series; and a current limiting circuit comprising a current limiting element, wherein the current limiting element is connected in parallel to some of the plurality of light-emitting units, so as to at least solve the technical problem in the prior art that it is difficult for a lighting device to achieve deep dimming at low cost, thereby achieving the technical effect of providing an improved lighting device having a simple structure and low cost and capable of achieving deep dimming at the same time.

### BRIEF DESCRIPTION OF THE DRAWINGS

The drawings of the description, constituting a part of the present application, are used for providing further understanding of the present application, and the illustrative embodiments of the present application and illustrations thereof are used to explain the present application, rather than constitute inappropriate limitation on the present application. In the drawings:

FIG. 1 is a schematic diagram of circuit connections of a lighting device in the prior art;

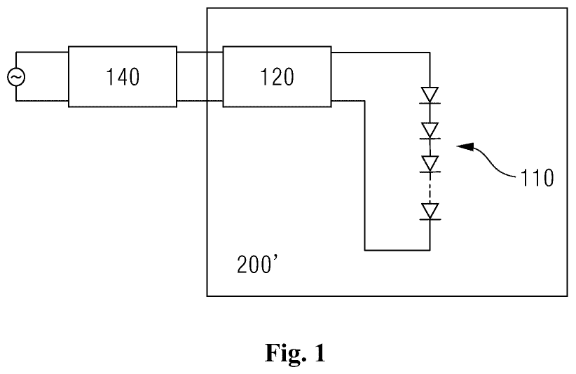

FIG. 2 is a schematic diagram of circuit connections of a lighting unit, a lighting device, and a lighting system according to the embodiments of the present application;

FIG. 3A is a schematic diagram showing the arrangement of a current limiting circuit in a lighting unit, a lighting device, and a lighting system according to a first exemplary embodiment of the present application, and FIG. 3B is a schematic diagram of the appearance of the lighting device corresponding to FIG. 3A;

FIG. 4A is a schematic diagram showing the arrangement of a current limiting circuit in a lighting unit, a lighting device, and a lighting system according to a second exemplary embodiment of the present application, and FIG. 4B is a schematic diagram of the appearance of the lighting device corresponding to FIG. 4A;

FIG. 5 is a schematic diagram showing the arrangement of a current limiting circuit in a lighting unit, a lighting device, and a lighting system according to a third exemplary embodiment of the present application; and

FIG. 6 is a schematic diagram showing the arrangement of a current limiting circuit in a lighting unit, a lighting device, and a lighting system according to a fourth exemplary embodiment of the present application.

### DETAILED DESCRIPTION

It should be noted that the embodiments in the present application and features in the embodiments can be combined with each other without conflicts. Hereinafter, the present application is described in detail with reference to the accompanying drawings and in conjunction with the embodiments.

It is to be noted that unless otherwise indicated, all technical and scientific terms used in the present application have the same meanings as those commonly understood by a person of ordinary skill in the art to which the present application belongs.

In the present application, unless specified to the contrary, directional terms such as “upper, lower, top and bottom” are generally used regarding the directions shown in the figures, or for the components themselves in vertical, perpendicular or gravity directions; likewise, for ease of understanding and description, “internal, external” refer to internal and external relative to the outline of each component itself, but the described directional terms are not used to limit the present application.

The object of the present application is to provide an improved lighting unit, lighting device, and lighting system, which can achieve a deep dimming function with a simple structure and low cost, and thus is suitable for large-scale applications.

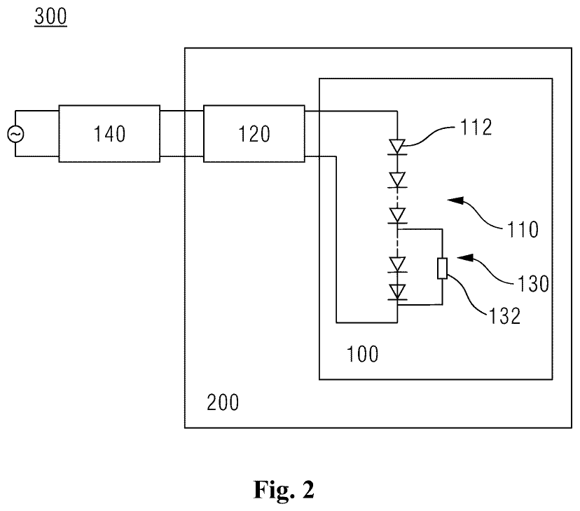

In light of this, the present application provides an improved lighting unit 100, a lighting device 200 comprising the lighting unit 100, and a lighting system 300 comprising the lighting device 200. FIG. 2 is a schematic diagram of circuit connections of a lighting unit, a lighting device, and a lighting system according to the embodiments of the present application. As shown in FIG. 2, the lighting unit 100 according to the present application is configured to connect to a drive element 120 and a dimmer 140. The lighting unit 100 comprises: a light-emitting assembly 110 comprising a plurality of light-emitting units 112 connected in series; and a current limiting circuit 130, wherein the current limiting circuit 130 comprises a current limiting element 132, and the current limiting element 132 is connected in parallel to some of the plurality of light-emitting units 112. Specifically, the current limiting element 132 is connected in parallel to a predetermined number of the light-emitting units 112, and the predetermined number is greater than or equal to one and smaller than the total number of the plurality of light-emitting units 112.

Accordingly, the present application further provides an improved lighting device 200. The lighting device 200 comprises the described lighting unit 100 and a drive element 120. An output end of the drive element 120 may be connected to the light-emitting assembly 110.

The present application also provides an improved lighting system 300. The lighting system 300 comprises the described lighting device 200 and a dimmer 140. An output end of the dimmer 140 may be connected to an input end of the drive element 120. In addition, an input end of the dimmer 140 may be connected to an AC power supply. In the present application, the dimmer 140 is, for example, a phase control dimmer that adjusts the output voltage by changing the phase of an AC voltage waveform.

In an embodiment where the current limiting circuit 130 is not added, the voltage output from the drive element 120 is smaller than the overall turn-on voltage of the plurality of light-emitting elements 112, none of the plurality of light-emitting elements 112 emits light. This situation imposes requirements on the voltage output from the drive element 120.

In particular, when the dimmer 140 performs deep dimming (e. g., dimming the brightness to 30% or less), the effective value of the voltage output from the dimmer may be reduced too much, causing the drive element (e. g., linear driver) 120 to be unable to maintain its output voltage higher than the overall turn-on voltage of the plurality of light-emitting elements 112. In this case, none of the light-emitting units 112 emits light, resulting in that the deep dimming of the lighting unit 100 is practically impossible.

However, in the present application, the added current limiting circuit 130 constitutes a bypass circuit of some of the light-emitting units 112 connected in parallel. When the voltage output from the drive element 120 is less than the overall turn-on voltage of the plurality of light-emitting units 112 but greater than the turn-on voltage of the remaining light-emitting units 112 other than the plurality of light-emitting units 112 connected in parallel, the loop formed by the remaining light-emitting units 112 and the current limiting circuit 130 will be turned on. In this case, the conduction current depends on the resistance of the current limiting element 132.

Therefore, with the described lighting unit 100 of the present application, even if the voltage output from the drive element 120 is lower than the overall turn-on voltage of the plurality of light-emitting units 112 due to deep dimming of the dimmer 140, the remaining light-emitting units 112 can still emit light as long as the voltage output from the drive element 120 is higher than the turn-on voltage of the remaining light-emitting units 112 other than the light-emitting unit 112 connected in parallel to the current limiting element 132 among the plurality of light-emitting units 112.

Thus, the lighting unit 100 of the present application can achieve deep dimming, as well as has a simple structure and low cost.

In the present application, the current limiting element 132 comprises, for example, at least one of a resistor, a diode and a transistor, and the current limiting circuit 130 comprises the current limiting element 132, and forms a bypass circuit connected in parallel to the some of the light-emitting unit 112.

In the present application, the light-emitting unit 112 is, for example, an LED light-emitting unit. Since the LED light-emitting unit has a fixed turn-on voltage, for example, the turn-on voltage of the red LED is about 1.8 V to 2.2 V, the turn-on voltage of the green LED is about 2.0 V to 3.5 V, the turn-on voltage of the blue LED is about 3.0 V to 3.5 V, and the turn-on voltage of the white LED is about 3.0 V to 3.5 V. Therefore, a partial turn-on voltage of the light-emitting assembly 110 can be preset by presetting a number of the light-emitting units 112 to be connected in parallel to the current limiting element 132 (i.e. setting the number of the remaining light-emitting units 112). In addition, the magnitude of the current of the remaining light-emitting units 112 when conducted can be preset by presetting a resistance value of the current limiting element 132, which allows for the setting of the luminous brightness of the remaining light-emitting units 112 during deep dimming.

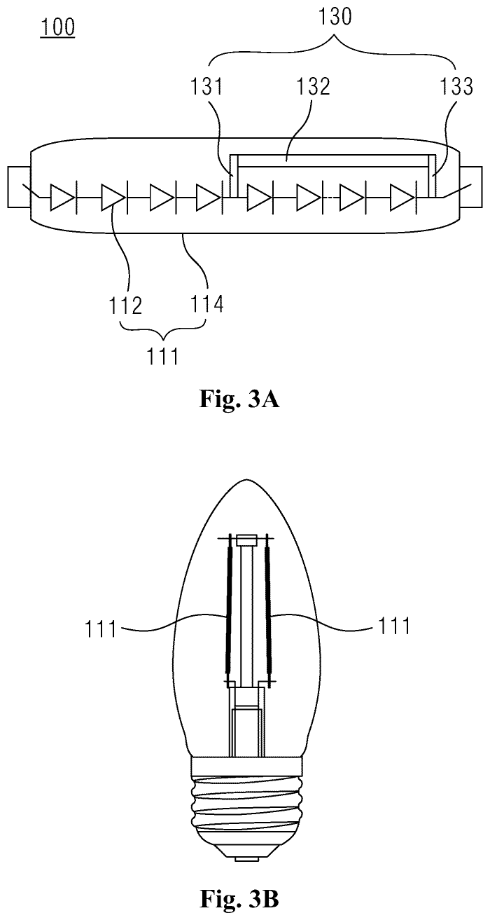

Further, in the present application, in order to achieve that the current limiting element 132 is only connected in parallel to some of the plurality of light-emitting units 112, the light-emitting assembly 110 further comprises at least one substrate 114, and the plurality of light-emitting units 112 are distributed on the at least one substrate 114, as shown in FIGS. 3A to 6. When the light-emitting assembly 110 comprises a plurality of substrates 114, at least one light-emitting unit 112 is arranged on each substrate 114.

In addition, in the present application, each substrate 114 and the light-emitting unit 112 arranged on the substrate may form a filament 111. Thus, the light-emitting assembly 110 comprising at least one substrate 114 means that it also comprises at least one filament 111. The number of the light-emitting units 112 arranged on each filament 111 (or each substrate 114) may be the same or different.

For example, when the turn-on voltage of the LED used is 3.2 V, 22 LED light-emitting units may be provided on one filament 111, and in that case, the turn-on voltage of one filament 111 is about 70 V. If the light-emitting assembly 110 comprises two filament 111, the lighting unit 100 is provided with one current limiting circuit 130, and a current limiting element 132 of the current limiting circuit 130 is connected in parallel to one filament 111, when the voltage output from the drive element 120 is between 70 V to 140 V due to the dimming of the dimmer, the light-emitting unit 112 on the other filament 111 which is not connected in parallel to the current limiting element 132 can emit light.

Further, in the present application, the number of the current limiting circuit 130 is not limited to one, and may also be multiple, allowing for the arrangement of a plurality of current limiting elements 132. In addition, the number of current limiting elements 132 in one current limiting circuit 130 is not limited to one, and may also be multiple. When there are a plurality of current limiting elements 132 due to any of the foregoing cases, the sum of the number of light-emitting units 112 connected in parallel to the plurality of current limiting elements 132 is less than the total number of light-emitting units 112 in the lighting unit 100.

Furthermore, in the case of a plurality of current limiting circuits 130, the plurality of current limiting circuits 130 may be arranged on the same substrate 114, or dispersedly arranged on different substrates in the case of a plurality of substrates.

In the present application, for one current limiting circuit 130, the following arrangement can be used: when the light-emitting assembly 110 comprises only one substrate 114, the current limiting circuit 130 is arranged on the substrate 114; and when the light-emitting assembly 110 comprises a plurality of substrates 114 connected in sequence, the current limiting circuit 130 is arranged on one of the plurality of substrates 114 or is arranged outside the plurality of substrates 114.

Next, the arrangement of one current limiting circuit 130 will be described with four exemplary embodiments. The first exemplary embodiment and the second exemplary embodiment describe a case in which the current limiting circuit 130 is arranged on the substrate 114, and the third exemplary embodiment and the fourth exemplary embodiment describe a case in which the current limiting circuit 130 is arranged outside the substrate 114.

FIG. 3A is a schematic diagram showing the arrangement of a current limiting circuit in a lighting unit, a lighting device, and a lighting system according to a first exemplary embodiment of the present application.

In the first exemplary embodiment, the light-emitting assembly 110 of the lighting unit 100 comprises two filaments 111. FIG. 3A shows that a current limiting circuit 130 is arranged on a substrate 114 of one of the filaments 111, and a current limiting element 132 of the current limiting circuit 130 is connected in parallel to some of the light-emitting units 112 on the filament 111. However, the present application is not limited thereto, and the light-emitting assembly 110 may also comprise three or more filaments 111. In this case, the current limiting element 132 may be connected in parallel to some or all of the light-emitting units 112 on the one filament 111. In addition, the light-emitting assembly 110 may comprise only one filament 111, and in this case, the current limiting element 132 is only connected in parallel to some of the light-emitting units 112 on the filament 111. In the first exemplary embodiment, the current limiting element 132 may be a resistor.

As shown in FIG. 3A, the current limiting element 132 includes a resistive material layer coated on a part of the surface of the substrate 114. A resistive material layer of a predetermined size (e.g., length, width, and height) may be pre-coated on a part of the surface of the substrate 114 to form a current limiting element 132 of a predetermined resistance value (e.g., 1 kΩ, 100 kΩ, etc.). The coating may employ semiconductor packaging processes such as sputtering or chemical vapor deposition (CVD) methods. The resistive material layer can be selected from materials having electrical conductivity, thermal stability, chemical stability, etc., such as a carbon-based material and a metal-based material.

After the resistive material layer is coated, the conductive material layers 131 and 133 may be coated on the surface of the substrate before or after the light-emitting units 112 are attached to the substrate 114. The conductive material may be metals such as copper or aluminum. The conductive material layers 131 and 133 are arranged on two ends of the resistive material layer (e.g., two ends in a lengthwise direction) and extend outward from the two ends of the resistive material layer such that the two extended ends are in contact with two ends of the some of the light-emitting units 112 to be connected in parallel, respectively. Thus, the current limiting circuit 130 is formed.

Then, the substrate 114, the current limiting circuit 130 and the light-emitting units 112 on the substrate 114 may be packaged by using a transparent film to form the filament 111. FIG. 3B shows a schematic diagram of the appearance of the lighting device corresponding to FIG. 3A. FIG. 3B shows a light-emitting assembly 110 comprising two filaments 111 in a lighting device 200, and a current limiting circuit 130 may be arranged on any of the filaments 111.

The current limiting circuit 130 is formed by means of the described coating method, and the current limiting circuit 130 is embedded on the substrate 114 of the filament 111. Therefore, the current limiting circuit 130 is stable and not easily damaged. In addition, embedding the current limiting circuit 130 in this manner does not change the appearance of the filaments 111, thereby not affecting the appearance of the lighting device 200.

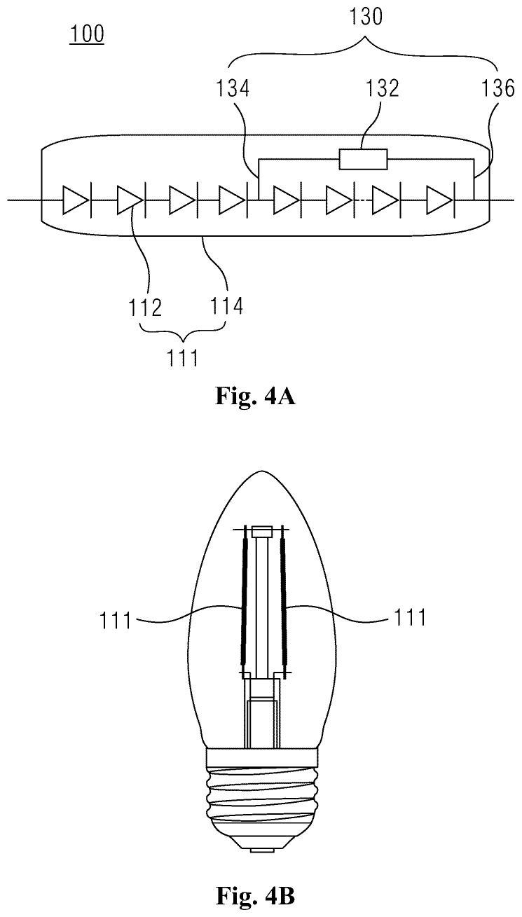

FIG. 4A is a schematic diagram showing the arrangement of a current limiting circuit in a lighting unit, a lighting device, and a lighting system according to a second exemplary embodiment of the present application.

In a second exemplary embodiment, the light-emitting assembly 110 of the lighting unit 100 comprises two filaments 111. FIG. 4A shows that one current limiting circuit 130 is arranged on a substrate 114 of one of the filaments 111, and a current limiting element 132 in the current limiting circuit 130 is connected in parallel to some light-emitting units 112 on the filament 111. Similar to the description of the first exemplary embodiment, the present application is not limited thereto. The light-emitting assembly 110 may also comprises three or more filaments 111, and the current limiting element 132 may be connected in parallel to some or all of the lighting elements 112 on one of the filaments 111. In addition, in the second exemplary embodiment, the current limiting element 132 may comprise at least one of a resistor, a diode, and a transistor.

As shown in FIG. 4A, the current limiting circuit 130 comprises a current limiting element 132, a first conductive wire 134 and a second conductive wire 136. One end of the current limiting element 132 is connected to one end of the some of the light-emitting units 112 to be connected in parallel on the substrate 114 via the first conductive wire 134, and the other end of the current limiting element 132 is connected to the other end of the some of the light-emitting units 112 via the second conductive wire 136.

The difference from the first exemplary embodiment is that, in the second exemplary embodiment, the current limiting circuit 130 is not formed by means of coating, but is formed by additionally attaching one current limiting element 132 and two conductive wires 134 and 136 to the substrate 114. Thus, the process of forming the current limiting circuit 130 is simple.

Then, the substrate 114, the current limiting circuit 130 and the light-emitting units 112 on the substrate 114 may be packaged by using a transparent film to form the filaments 111. FIG. 4B shows a schematic diagram of the appearance of the lighting device corresponding to FIG. 4A. FIG. 4B shows a light-emitting assembly 110 comprising two filaments 111, and a current limiting circuit 130 may be arranged on any of the filaments 111. The schematic diagram of the appearance of the lighting device shown in FIG. 4B is the same as that shown in FIG. 3B. That is, similarly to the first exemplary embodiment, by additionally attaching the current limiting circuit 130 on the substrate 114 of the filament 111, the appearance of the filaments 111 and the appearance of the lighting device 200 are not affected.

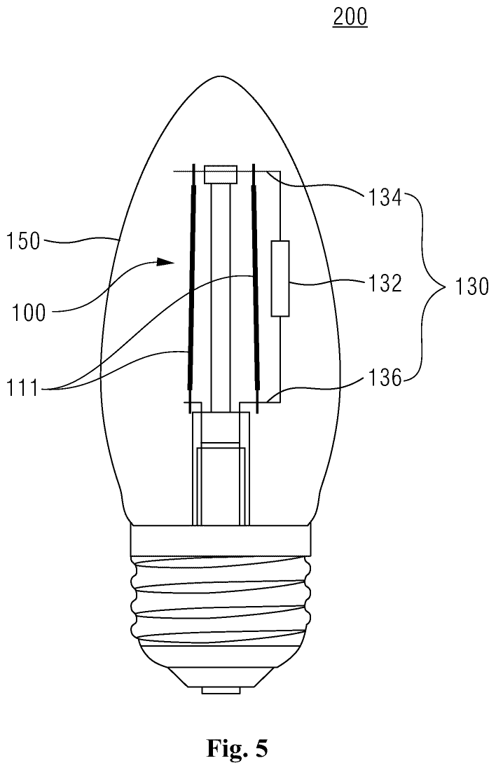

FIG. 5 is a schematic diagram of the arrangement of a current limiting circuit in a lighting unit, a lighting device and a lighting system according to a third exemplary embodiment of the present application. In the third exemplary embodiment, the current limiting circuit 130 is arranged outside the substrate 114s and filaments 111. At this time, the light-emitting assembly 110 comprises at least two filaments 111.

FIG. 5 shows that the light-emitting assembly 110 of the lighting unit 100 comprises two filaments 111, and outside one of the filaments 111 there is arranged one current limiting element 132 connected in parallel therewith. Similar to the description of the first and second exemplary embodiments, the present application is not limited thereto. The light-emitting assembly 110 also comprises three or more filaments 111. In addition, in the third exemplary embodiment, the current limiting element 132 may include at least one of a resistor, a diode, and a transistor.

As shown in FIG. 5, the current limiting circuit 130 comprises a current limiting element 132, a first conductive wire 134 and a second conductive wire 136, wherein one end of the current limiting element 132 is connected to one end of a filament 111 via the first conductive wire 134, and the other end of the current limiting element 132 is connected to the other end of the filament 111 via the second conductive wire 136. Thus, the current limiting element 132 is connected in parallel to all the light-emitting units 112 on the filament 111.

Further, when the light-emitting assembly 110 comprises more filaments 111, one end of the current limiting element 132 may be connected to one end of at least one pre-determined filament 111 via the first conductive wire 134, and the other end of the current limiting element 132 may be connected to the other end of the at least one pre-determined filament 111 via the second conductive wire 136. Thus, the current limiting element 132 is connected in parallel to all the light-emitting units 112 on the at least one filament 111.

By presetting the number of filaments, the number of light-emitting units on each filament, and the location of at least one filament to be connected in parallel, the current limiting element 132 can be connected in parallel to the predetermined number of light-emitting units 112 in the lighting unit 100.

In addition, the current limiting circuit 130 is arranged by directly paralleling the current-limiting element 132 outside the filaments, as shown in FIG. 5, making the current limiting circuit 130 visible in the lighting unit 100. Thus, it is easy to check whether the current limiting circuit 130 is damaged, and it is easy to replace the current limiting circuit 130.

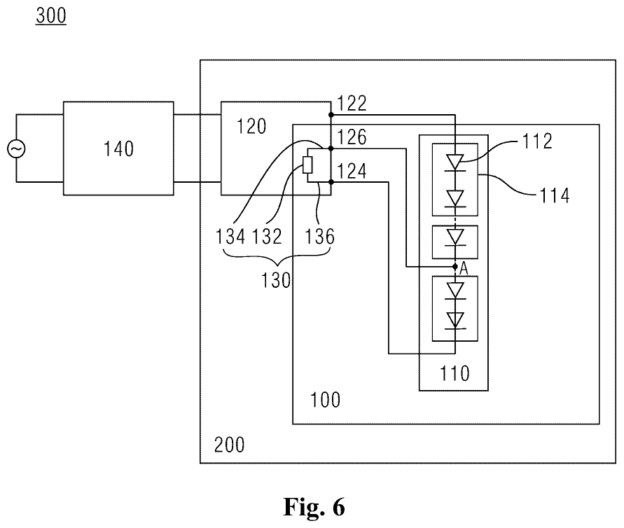

FIG. 6 is a schematic diagram showing the arrangement of a current limiting circuit in a lighting unit, a lighting device, and a lighting system according to a fourth exemplary embodiment of the present application. In the fourth exemplary embodiment, the current limiting circuit 130 is arranged outside the substrates 114 and the filaments 111. In practice, the current limiting circuit 130 is arranged within the drive element 120. In this case, the light-emitting assembly 110 comprises at least two filaments 111. In addition, in the fourth exemplary embodiment, the current limiting element 132 may comprise at least one of a resistor, a diode, and a transistor.

As shown in FIG. 6, the drive element 120 comprises a first output end 122, a second output end 124, and a third output end 126. The first output end 122 is connected to one end of the light-emitting assembly 110, the second output end 124 is connected to the other end of the light-emitting assembly 110, and the third output end 126 is connected to a point (as indicated by point A) between two preset adjacent filaments among the plurality of filaments 111 of the light-emitting assembly 110.

Further, the current limiting circuit 130 comprises a current limiting element 132, a first conductive wire 134 and a second conductive wire 136, wherein one end of the current limiting element 132 is connected to the third output end 126 via the first conductive wire 134, and the other end of the current limiting element 132 is connected to the second output end 124 via the second conductive wire 136. Thus, the current limiting element 132 is connected in parallel to the light-emitting units 112 located between the other end of the light-emitting member 110 and the point A.

Alternatively, the other end of the current limiting element 132 can also be connected to the first output 122 instead of the second output 124 via the second conductive wire 136. Thus, the current limiting element 132 is connected in parallel to the light-emitting units 112 located between the one end of the light-emitting member 110 and the point A.

By arranging the current limiting circuit 130 within the drive element 120, an improved lighting unit 100 having a simple structure and low cost and capable of achieving deep dimming can be formed without a complex manufacturing process.

In addition, in the present application, the lighting device 200 can further comprise a bulb shell 150 (as shown in FIG. 5) surrounding the lighting unit 100. Further, the lighting device 200 according to the embodiments of the present application, which has the bulb shell 150 shown in FIG. 5, may be referred to as a filament lamp. However, the present application is not limited thereto, and the lighting device 200 may also have a bulb shell in other forms (for example, a lamp shade of a ceiling lamp), so as to present a lamp in any form.

It should be noted that the terms used herein are for the purpose of describing specific embodiments only and are not intended to limit exemplary embodiments according to the present application. As used herein, the singular form is intended to comprise the plural form as well, unless the context clearly indicates otherwise, and further it should be understood that the terms “comprises” and/or “comprising” when used in the present description, specify the presence of features, steps, operations, devices, assemblies and/or combinations thereof.

It should be noted that the terms “first”, “second” etc., in the description, claims, and accompanying drawings of the present application are used to distinguish similar objects, and are not necessarily used to describe a specific sequence or order. It should be understood that the data so used may be interchanged where appropriate so that the embodiments of the present application described herein can be implemented in sequences other than those illustrated or described herein. The nouns and pronouns regarding people in this application are not limited to a particular gender.

The content above merely relates to preferred embodiments of the present application and is not intended to limit the present application. For a person skilled in the art, the present application may have various modifications and variations. Any modifications, equivalent replacements, improvements, etc. made within the spirit and principle of the present application shall all belong to the scope of protection of the present application.

1. A lighting unit, which is configured to connect to a drive element and a dimmer, wherein the lighting unit comprises:
a light-emitting assembly comprising a plurality of light-emitting units connected in series; and
a current limiting circuit comprising a current limiting element, the current limiting element being connected in parallel to some of the plurality of light-emitting units.

2. The lighting unit according to claim 1, wherein the light-emitting assembly further comprises at least one substrate, and the plurality of light-emitting units are distributed on the at least one substrate.

3. The lighting unit according to claim 2, wherein
the light-emitting assembly comprises only one substrate, and the current limiting circuit is arranged on the substrate; or
the light-emitting assembly comprises a plurality of substrates connected in sequence, wherein at least one light-emitting unit is arranged on each of the substrates, and the current limiting circuit is arranged on one of the plurality of substrates or is arranged outside the plurality of substrates.

4. The lighting unit according to claim 3, wherein the current limiting circuit is arranged on one substrate, and the current limiting element comprises a resistive material layer coated on a part of the surface of the substrate.

5. The lighting unit according to claim 4, wherein the current limiting circuit further comprises conductive material layers coated on the surface of the substrate, the conductive material layers are arranged at two ends of the resistive material layer and extend outwards from the two ends of the resistive material layer, and two extended ends of the conductive material layers are respectively in contact with two ends of the some of the light-emitting units.

6. The lighting unit according to claim 3, wherein the current limiting circuit is arranged on one substrate, the current limiting circuit further comprises a first conductive wire and a second conductive wire, one end of the current limiting element is connected to one end of the some of the light-emitting units on the substrate via the first conductive wire, and the other end of the current limiting element is connected to the other end of the some of the light-emitting units via the second conductive wire.

7. The lighting unit according to claim 3, wherein the light-emitting assembly comprises a plurality of substrates, and the current limiting circuit is arranged outside the plurality of substrates,
wherein each of the substrates and at least one of the light-emitting units arranged on the substrate form a filament,
the current limiting circuit further comprises a first conductive wire and a second conductive wire, one end of the current limiting element is connected to one end of at least one pre-determined filament among the plurality of filaments via the first conductive wire, and the other end of the current limiting element is connected to the other end of the at least one filament via the second conductive wire.

8. The lighting unit according to claim 3, wherein the light-emitting assembly comprises a plurality of substrates, and the current limiting circuit is arranged outside the plurality of substrates,
wherein each of the substrates and at least one of the light-emitting units arranged on the substrate form a filament,
the drive element comprises a first output end, a second output end and a third output end, wherein the first output end is connected to one end of the light-emitting assembly, the second output end is connected to the other end of the light-emitting assembly, and the third output end is connected to a point between two preset adjacent filaments among the plurality of filament,
the current limiting circuit further comprises a first conductive wire and a second conductive wire, one end of the current limiting element is connected to the third output end via the first conductive wire, and the other end of the current limiting element is connected to the first output end or the second output end via the second conductive wire.

9. The lighting unit according to claim 1, wherein there are a plurality of current limiting circuits, and the sum of the number of the light-emitting units connected in parallel to the plurality of the current limiting elements included in the plurality of the current limiting circuits is less than the total number of the light-emitting units in the light-emitting assembly.

10. The lighting unit according to claim 1, wherein the light-emitting unit is an LED light-emitting unit.

11. The lighting unit according to claim 1, wherein the current limiting element is a resistor, and the current limiting circuit is a resistor circuit.

12. A lighting device which is configured to connect to a dimmer, wherein the lighting device comprises:
the lighting unit according to claim 1; and
a drive element, an output end of the drive element being connected to a light-emitting assembly of the lighting unit.

13. The lighting device according to claim 12, wherein the drive element is a linear drive element.

14. A lighting system, wherein the lighting system comprises:
a drive element, an output end of the drive element being connected to a light-emitting assembly of the lighting unit;
a dimmer, an output end of the dimmer being connected to an input end of a drive element of the lighting device;
a lighting unit, which is configured to connect to a drive element and a dimmer, wherein the lighting unit comprises:
a light-emitting assembly comprising a plurality of light-emitting units connected in series; and
a current limiting circuit comprising a current limiting element, the current limiting element being connected in parallel to some of the plurality of light-emitting units.

15. The lighting system according to claim 14, wherein the light-emitting assembly further comprises at least one substrate, the current limiting element comprises a resistive material layer coated on a part of the surface of the substrate.
